(19) United States
(12) Patent Application Publication
(10) Pub. No.: US 2025/0289307 A1
(43) Pub. Date: Sep. 18, 2025

(54) INFORMATION DISPLAY DEVICE FOR VEHICLE

(71) Applicant: TOYOTA JIDOSHA KABUSHIKI KAISHA, Toyota-shi (JP)

(72) Inventor: Yuki YAMAMOTO, Toyota-shi (JP)

(73) Assignee: TOYOTA JIDOSHA KABUSHIKI KAISHA, Toyota-shi (JP)

(21) Appl. No.: 18/982,186

(22) Filed: Dec. 16, 2024

(30) Foreign Application Priority Data
Mar. 14, 2024 (JP) 2024-040306

(51) Int. Cl. B60K 35/28; B60K 35/90

(52) U.S. Cl. CPC B60K 35/28; B60K 35/90; B60K 2360/119; B60K 2360/171; B60K 2360/176; B60K 2360/177

(57) ABSTRACT

The information display device of the vehicle displays an image representing a surrounding environment of the own vehicle on a display based on detection information of an external camera of the own vehicle. The information display device of the vehicle includes an abnormality detection unit that detects occurrence of an abnormality in an in-vehicle component of the own vehicle, and an image display unit that displays an icon of the own vehicle corresponding to the own vehicle on a display. When the occurrence of the abnormality is detected, the image display unit displays the abnormality display indicating the occurrence of the abnormality on the own vehicle icon so as to correspond to the position of the in-vehicle component in which the abnormality has occurred in the own vehicle.

### CROSS-REFERENCE TO RELATED APPLICATION

This application claims priority to Japanese Patent Application No. 2024-040306 filed on Mar. 14, 2024, incorporated herein by reference in its entirety.

### BACKGROUND

### 1. Technical Field

The disclosure relates to an information display device for a vehicle.

### 2. Description of Related Art

Conventionally, there is known vehicle an information providing device in which, when a warning light is turned on or is blinking, what to do and what the warning light means, and so forth, are instructed to a meter display, as information related to the warning light.

### SUMMARY

In the above-described conventional apparatus, what to do and what the warning light means, and so forth, are displayed on the meter display in a specific sentence or the like. In the information display device of the vehicle, there is room for improvement in enabling a user to intuitively recognize an in-vehicle component of an own vehicle related to provision information, which is information provided to the user, such as occurrence of an abnormality, for example.

An aspect of the disclosure is an information display device for a vehicle, displaying an image representing a surrounding environment of an own vehicle on a display based on detection information of an external sensor of the own vehicle, the information display device including
a provision information acquisition unit for acquiring provision information that is information provided to a user of the own vehicle with respect to an in-vehicle component of the own vehicle, and
an image display unit for displaying an own vehicle icon corresponding to the own vehicle, on the display, in which,
when the provision information is acquired, the image display unit displays an information provision display representing the provision information, superimposed on the own vehicle icon, so as to correspond to a position of the in-vehicle component related to the provision information in the own vehicle.

In the information display device for a vehicle according to an aspect of the disclosure, the image representing the surrounding environment of the own vehicle is displayed on the display together with the own vehicle icon corresponding to the own vehicle, based on the detection information of the external sensor of the own vehicle. When the provision information is acquired, the information provision display representing the provision information is displayed superimposed on the own vehicle icon, so as to correspond to the position of the in-vehicle component related to the provision information in the own vehicle. As a result, when the occurrence of an abnormality in the in-vehicle component is detected as the provision information, for example, the user can intuitively recognize the in-vehicle component of the own vehicle related to the provision information, as compared with a case in which only a tell-tale warning light stipulated by law is turned on, or the meaning and so forth of the tell-tale warning light, is displayed in detail in a sentence.

In an embodiment, the information display device of the vehicle includes a virtual space generating unit for generating virtual space corresponding to the surrounding environment of the own vehicle, based on the detection information of the external sensor. The image display unit may display an image, in the virtual space, as viewed from a virtual viewpoint that is operated by the user of the own vehicle, on the display, and
the own vehicle icon may be a three-dimensional icon corresponding to the own vehicle that is placed in the virtual space.

In this case, the information providing display is displayed so as to be superimposed on the three-dimensional own vehicle icon, and accordingly the user can be enabled to more intuitively recognize the in-vehicle component of the own vehicle related to the provision information.

In an embodiment, when the provision information with respect to the in-vehicle component, other than an exterior of the own vehicle, is acquired, the image display unit may delete an exterior image of the own vehicle icon, display an internal structure image corresponding to an internal structure of the own vehicle on the display, and display the information provision display, superimposed on the internal structure image.

In this case, the user can be enabled to easily recognize in which in-vehicle component the provision information has occurred, in the internal structure of the own vehicle.

According to various aspects of the disclosure, the user can be enabled to intuitively recognize the in-vehicle component of the own vehicle related to the provision information.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating an information display device of a vehicle according to an embodiment;

FIG. 2 is a diagram for explaining an own vehicle icon and a virtual viewpoint;

FIG. 3 is a diagram illustrating a display example of an image corresponding to a surrounding environment and an own vehicle icon;

FIG. 4A is a diagram showing an example of display in which an abnormality display is superimposed on an own vehicle icon;

FIG. 4B is a diagram showing another display in which an abnormal display is superimposed on an own vehicle icon;

FIG. 5A is a diagram illustrating an example of a state where a virtual component position of an in-vehicle component in which an anomaly has occurred is not included in an area displayed on a display;

FIG. 5B is a diagram illustrating an example of a state in which a virtual component position of an in-vehicle component in which an anomaly has occurred is included in an area displayed on a display; and

FIG. 6 is a flow chart illustrating an exemplary process of ECU of FIG. 1.

### DETAILED DESCRIPTION OF EMBODIMENTS

Hereinafter, embodiments of the present disclosure will be described with reference to the drawings.

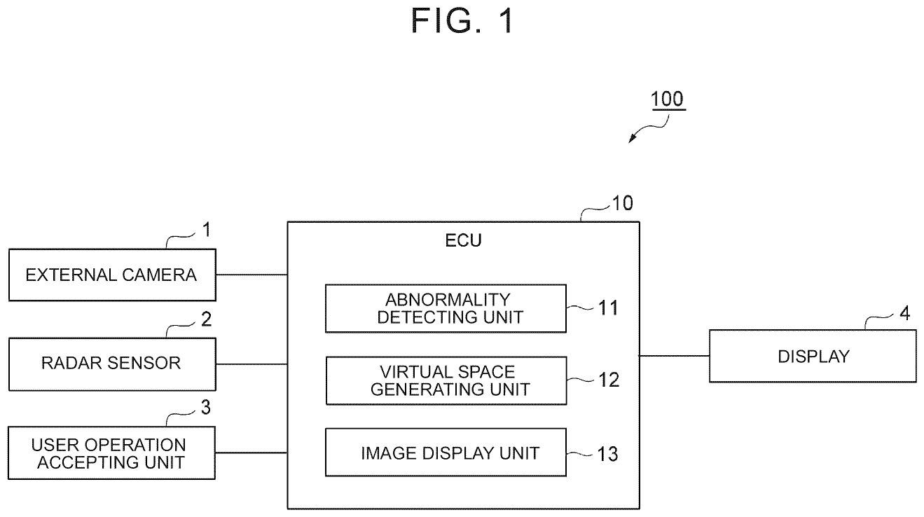

FIG. 1 is a block diagram illustrating an information display device 100 of a vehicle according to an embodiment. The information display device 100 of the vehicle shown vehicle in FIG. 1 is a device mounted on a vehicle such as a passenger car or a freight car (hereinafter, referred to as an own vehicle) and configured to support recognition of a surrounding environment of the vehicle by a user. The information display device 100 of the vehicle displays an image representing a surrounding environment of the own vehicle on a display based on detection information of an external sensor of the own vehicle. As an example, the information display device 100 of the vehicle generates a virtual space reflecting the surrounding environment of the own vehicle, and displays an image in the virtual space viewed from a virtual viewpoint operated by the user on the display. The vehicle information display device 100 displays the surrounding environment of the own vehicle as a so-called 3D view on a display.

The user may be a driver of the own vehicle, an occupant of the own vehicle, or an owner of the own vehicle. The user may be an operator who remotely supports the own vehicle by the remote support system. In the remote support system, an operator can make a determination (determination of travel, right-left turn, stop, or the like) of traveling of the own vehicle or a driving operation of the own vehicle through a remote support facility provided outside the vehicle and capable of communicating with the own vehicle. The own vehicle is not limited to a vehicle that can be remotely supported by a remote support system. The own vehicle may be a vehicle having an automatic driving function or may be a vehicle having no automatic driving function.

### Configuration of Information Display Device of Vehicle

As illustrated in FIG. 1, the vehicle information display device 100 includes an ECU (Electronic Control Unit) 10. ECU 10 is an electronic control unit that comprehensively manages the information display device 100 of vehicles. ECU 10 includes a CPU (Central Processing Unit) and a storage unit. The storage unit includes, for example, ROM (Read Only Memory), RAM (Random Access Memory), and EEPROM (Electrically Erasable Programmable Read-Only Memory). In ECU 10, for example, various functions are realized by executing a program stored in a storage unit by a CPU. ECU 10 may be composed of a plurality of electronic units. ECU 10 is connected to an external camera 1 (external sensor), a radar sensor 2 (external sensor), a user operation accepting unit 3, and a display 4.

The external camera 1 is an imaging device that captures an image of an external state of the own vehicle. The external camera 1 includes, for example, a front camera that captures an image of the front of the own vehicle, a back camera that captures an image of the rear of the own vehicle, and a side camera that captures an image of the left and right sides of the own vehicle. The number of cameras of the external camera 1 is not particularly limited, and may be one. The external camera 1 transmits the captured image information to 10 ECU 10.

The radar sensor 2 is a detection device that detects an object around the own vehicle using radio waves (for example, millimeter waves) or light. The radar sensor 2 may include a millimeter-wave radar or a lidar (LIDAR: Light Detection and Ranging). The radar sensor 2 transmits object detection data related to the detected object to ECU 10. The radar sensor 2 and the external camera 1 constitute an external sensor for detecting the surrounding environment of the own vehicle. The object detection information of the radar sensor 2 or the captured image information of the external camera 1 corresponds to the detection information of the external sensor.

The user operation accepting unit 3 is a device that accepts an operation of a virtual viewpoint by a user. The user operation accepting unit 3 can be, for example, an inputting unit of an HMI (Human Machine Interface) provided in the own vehicle. The input unit includes, for example, a touch panel display, a button, a lever, a switch, and the like. In addition, the user operation accepting unit 3 may be capable of accepting an operation by speech recognition or gesture.

As the user operation accepting unit 3, a portable terminal communicatively connected to the own vehicle or an input device of a computer may be available. In addition, an operator terminal of the remote support system may be available as the user operation accepting unit 3.

The display 4 is, for example, a center display mounted on a dashboard of the own vehicle. The display 4 may be a display of a tablet-type computer that can be installed in the own vehicle, or may be a HUD (Head Up Display). The display 4 is not limited to being mounted on the own vehicle. The display 4 may be a display for an operator of a remote support system provided in a facility remote from the own vehicle. The display 4 may be a display of a mobile terminal carried by the user, or may be a display of a tablet computer or a desktop computer of the user.

Next, the functional configuration of ECU 10 will be described. As illustrated in FIG. 1, ECU 10 includes an abnormality detecting unit 11 (provision information acquisition unit), a virtual space generating unit 12, and an image display unit 13. Some of the functions of ECU 10 described below may be implemented in a server (e.g., a server of a remote assistance system), a mobile terminal, or a computer (e.g., a tablet-type computer or a desktop-type computer) capable of communicating with the own vehicle.

The abnormality detecting unit 11 detects (acquires) the occurrence of an abnormality in the in-vehicle component of the own vehicle as the provision information about the in-vehicle component of the own vehicle. The abnormality detecting unit 11 detects at least an occurrence of an abnormality in an in-vehicle component related to the tell-tale (Tell-tale) which is a warning lamp defined by laws and regulations by a known vehicle method.

The telltale means a warning light and an indicator light installed or displayed on a speedometer, a dashboard, or an instrument panel of the own vehicle. The telltale is predefined as a predetermined icon for visually communicating the state of the various systems of the own vehicle to the user.

As a telltale, for example, a yellow icon of an engine check indicating an abnormality of an engine system, a red icon of an oil jug indicating a decrease in oil pressure of an engine oil (a hydraulic pressure warning lamp), a red icon of a battery indicating a decrease in a state of charge of a battery or a power generation failure (a charging warning lamp), a red icon of a thermometer (overheat) on a water surface indicating overheating of coolant, a cross section of a tire indicating a decrease in air pressure of a tire, and “!” Yellow icons (low tire pressure), yellow icons (ABS warning lights) of “ABS” surrounded by circles indicating anomalies such as ABS and travel control systems of the own vehicle, and “!” surrounded by circles indicating insufficient brake fluid of the hydraulic brake Examples thereof include a yellow icon (a brake warning light), a yellow or red icon (a SRS airbag warning light, a side airbag abnormality, and the like) indicating an abnormality in the state of the airbag, a yellow icon of a light bulb indicating an abnormality in the lights, and a red icon in a plan view of the vehicle indicating an open state of the door.

The virtual space generating unit 12 generates a virtual space corresponding to the surrounding environment of the own vehicle based on the detection information of the external sensor. The virtual space generating unit 12 generates a virtual space, for example, based on captured image information of the external camera 1. The surrounding environment of the own vehicle includes, for example, a position of a white line of a lane on which the own vehicle travels. The surrounding environment of the own vehicle may include a situation (a position, a traveling direction, or the like) of another vehicle such as a preceding vehicle or a parallel-running vehicle of an adjacent vehicle.

The virtual space is generated as, for example, a 3D image obtained by synthesizing a plurality of images. The method of synthesizing an image is not particularly limited. The virtual space generating unit 12 generates a virtual space as a 3D image by projecting images onto a global coordinate system serving as a reference of the virtual space and associating overlapping pixels with each other.

The virtual space generating unit 12 arranges the own vehicle icon corresponding to the own vehicle in the virtual space. The own vehicle icon is arranged as a three-dimensional icon in the shape of a vehicle. The own vehicle icon can be formed by a CG process such as a polygon, a voxel, or the like. The virtual space generating unit 12 may generate an own vehicle icon reflecting the state of the own vehicle. The virtual space generating unit 12 may reflect the lighting state of the lighting device of the own vehicle (the lighting state of the headlight, the direction indicator, the braking light, and the like) on the lighting state of the lighting device of the own vehicle icon, or may reflect the steering angle of the tire of the own vehicle on the tire of the own vehicle icon. The shape and size of the own vehicle icon are set in advance according to the vehicle type.

When the other vehicle is recognized based on the captured image information of the external camera 1, the virtual space generating unit 12 may arrange three-dimensional other vehicle icons corresponding to the other vehicle in the virtual space. Similarly, the virtual space generating unit 12 may arrange the three-dimensional pedestrian icon in the virtual space. The virtual space generating unit 12 may recognize the other vehicle or the like based on the object detection information of the radar sensor 2 instead of the captured image information of the external camera 1, or may recognize the other vehicle or the like using both the external camera 1 and the radar sensor 2.

The image display unit 13 displays an own vehicle icon corresponding to the own vehicle on the display 4. As an example, the image display unit 13 displays an image in the virtual space viewed from a virtual viewpoint operated by the user of the own vehicle on the display 4. Here, the own vehicle icon is a three-dimensional icon corresponding to the own vehicle arranged in the virtual space.

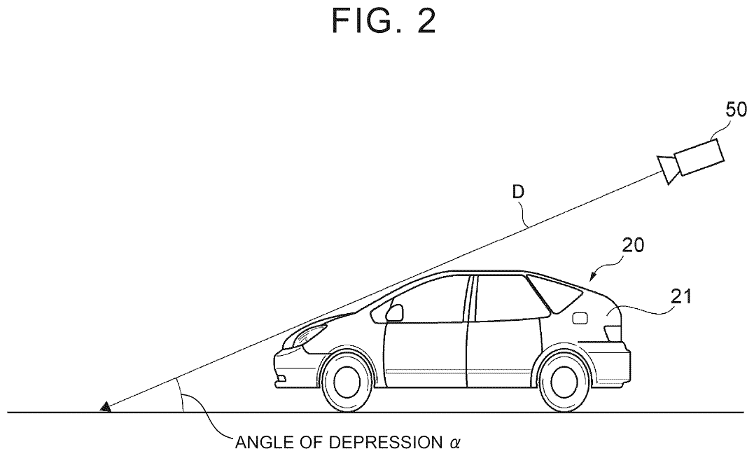

FIG. 2 is a diagram for explaining an own vehicle icon and a virtual viewpoint. FIG. 2 shows the own vehicle icon 20 and the virtual viewpoint 50. The plane on which the own vehicle icon 20 is arranged corresponds to the horizontal plane of the global coordinate system. FIG. 2 shows a line of sight D of the virtual viewpoint 50 and an angle of depression a of the virtual viewpoint 50. In FIG. 2, the virtual viewpoint 50 is illustrated as an icon of a camera for ease of understanding. The depression angle a is an angle formed between the horizontal plane of the global coordinate system and the line of sight D or the plane on which the own vehicle icon 20 is arranged in the vertical plane. Note that it is not essential to display the virtual viewpoint 50 as an icon on the virtual space.

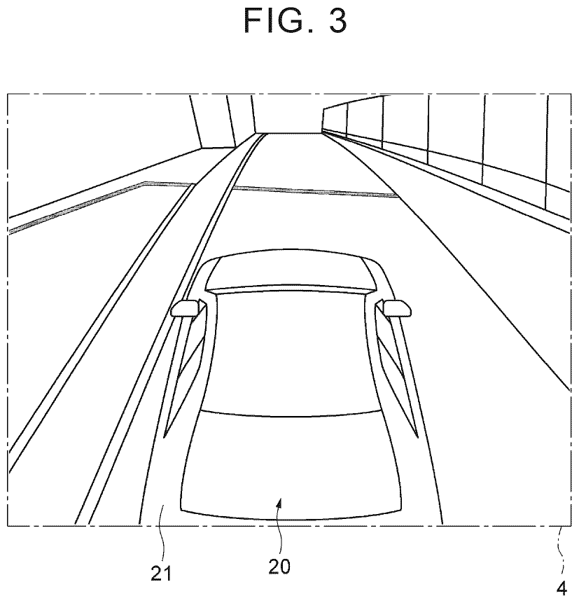

FIG. 3 is a diagram illustrating a display example of an image corresponding to a surrounding environment and an own vehicle icon. The image display unit 13 moves the virtual viewpoint 50 in accordance with the user's operation input to the user operation accepting unit 3. The image display unit 13 changes the orientation and size of the image and the own vehicle icon corresponding to the surrounding environment displayed on the display 4 in accordance with the position of the virtual viewpoint 50. In FIG. 3, the own vehicle icon 20 is displayed on the display 4 at an angle viewed from behind. The example of FIG. 3 corresponds to the field of view when the own vehicle icon 20 is viewed from the virtual viewpoint 50 in the positional relationship as shown vehicle in FIG. 2. The exterior image 21 is an image constituting the surface of the own vehicle icon 20. The exterior image 21 may be a portion corresponding to the exterior in the polygon, voxel, or the like of the own vehicle icon 20.

When the occurrence of an abnormality in the in-vehicle component is detected, the image display unit 13 displays an abnormality display (an information providing display indicating the provision information) indicating the occurrence of the abnormality superimposed on the own vehicle icon so as to correspond to the position of the in-vehicle component in which the abnormality has occurred in the own vehicle. The position of the in-vehicle component in which the abnormality has occurred in the own vehicle means where the in-vehicle component in which the abnormality has occurred is actually situated in the actual own vehicle. The abnormality display indicating the occurrence of the abnormality is a display for indicating the information on the in-vehicle component in which the abnormality has occurred in the virtual space.

The abnormality display may include a marking arranged at a position of the virtual space corresponding to the position of the in-vehicle component in which the abnormality has occurred in the own vehicle. The marking may be a region image occupying a certain region in the virtual space. The region image may be a region having a shape that occupies a certain area on the display 4 such as a circle, an ellipse, or a polygon as an edge.

The region image may be filled with the inside of the edge, or the inside of the edge may be transparent or translucent. The marking may be a point or the like arranged in the virtual space. The marking may include a tail icon. However, when the type of the in-vehicle component in which the abnormality has occurred corresponds to the virtual component position, the virtual component position can be visually recognized. In this regard, the display of the abnormality display makes it easier to intuitively recognize the type and the like of the in-vehicle component in which the abnormality has occurred, rather than displaying only the icon of the tell tail including the meaning of the abnormality of the plurality of in-vehicle components.

The display color of the marking may be changed in accordance with the urgency of the abnormality caused by the in-vehicle component in which the abnormality has occurred. The display color of the marking may be red for an abnormality in which the degree of urgency is equal to or higher than a certain level, for example, when there is a possibility that further damage such as overheating of the engine may occur. The color of the marking may be yellow for an abnormality in which the degree of urgency, such as an ABS system-abnormality, is not equal to or greater than a certain level.

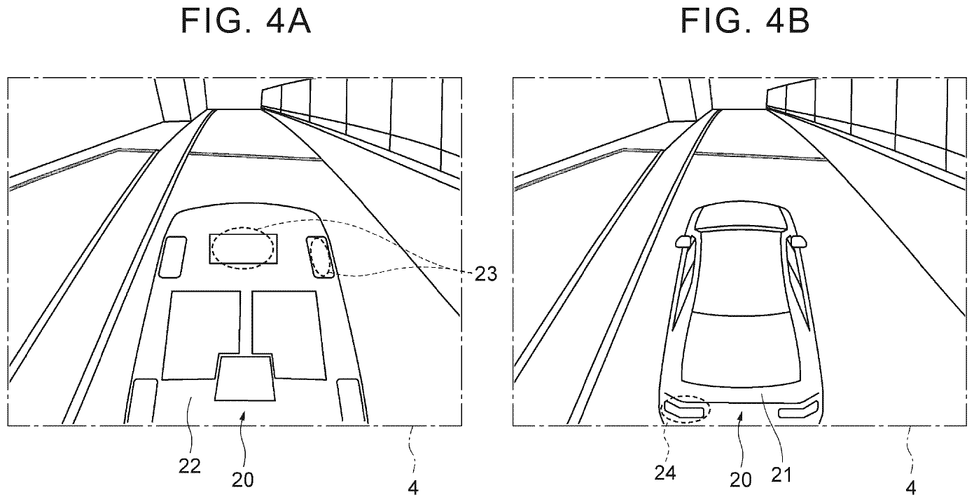

For example, when the occurrence of an abnormality in an in-vehicle component other than the exterior of the own vehicle is detected, the image display unit 13 deletes the exterior image 21 of the own vehicle icon 20, displays the internal structure image 22 on the display 4, and displays the abnormality display by superimposing the abnormality display on the internal structure image 22. FIG. 4A is a diagram illustrating an example of display in which an abnormality display 23 is superimposed on an own vehicle icon. In FIG. 4A, the exterior image 21 (see FIG. 2) of the own vehicle icon 20 is deleted, and the internal structure image 22 is displayed on the display 4. As shown in FIG. 4A, when an abnormality is detected in an in-vehicle component other than the exterior of the own vehicle, the abnormality display 23 is superimposed on the internal structure images 22. In the example of FIG. 4A, the abnormality display 23 is schematically shown vehicle as an ellipse with a dashed line.

The in-vehicle component other than the exterior of the own vehicle means an in-vehicle component in which the virtual component position may exist on the internal structure image 22. The virtual component position is a position of the in-vehicle component related to the provision information in the own vehicle. The virtual component position is a position of the in-vehicle component in the own vehicle icon 20 in the virtual space corresponding to the actual position of the in-vehicle component in the own vehicle. Examples of the in-vehicle components other than the exterior of the own vehicle include an engine, a battery, an ABS system, a travel control system, a hydraulic brake, an airbag, and the like. Examples of the abnormality to the in-vehicle components other than the exterior of the own vehicle include an abnormality in the engine system, a decrease in the oil pressure of the engine oil, a decrease in the state of charge of the battery or a power generation failure, overheating of the coolant, a decrease in the air pressure of the tire, an abnormality in ABS system and the travel control system of the own vehicle, a shortage of brake fluid of the hydraulic brake, an abnormality in the state of the airbag, and the like. In the example f FIG. 4A, the abnormality display 23 indicates an abnormality of the engine-system and a decrease in the pneumatic pressure of the tire.

The internal structure image 22 is a three-dimensional icon corresponding to the internal structure of the own vehicle, and is arranged in a virtual space so as to be covered with the exterior image 21 of the own vehicle icon 20. Various internal structures may be shown vehicle in the internal structure image 22, such as an engine, a tire, a battery, an inverter, etc. For example, the own vehicle icon 20 is enlarged in accordance with a pinch-out operation of the user input to the touch panel of the display 4 as the user operation accepting unit 3. As a result of the virtual viewpoint 50 approaching the own vehicle icon 20, it enters a predetermined approach area. At this time, the image display unit 13 deletes the exterior image 21 of the own vehicle icon 20 and displays the internal structure image 22 on the display 4.

For example, the image display unit 13 may gradually delete the exterior image 21 of the own vehicle icon 20 when the exterior image 21 of the own vehicle icon 20 is deleted and the internal structure image 22 is displayed on the display 4. When the image display unit 13 deletes the exterior image 21 of the own vehicle icon 20 and displays the internal structure image 22 on the display 4, for example, when the air pressure drop of the tire is not generated as an abnormality, as compared with the case where the air pressure drop of the tire as an abnormality occurs, the transparency of the part of the tire in the internal structure image 22 may be increased and displayed on the display 4. Similarly, the transparency of an in-vehicle component other than the tire may be changed according to the presence or absence of an abnormality.

The predetermined approach area is a threshold value of a position of the virtual viewpoint 50 in the virtual space for switching the deleting of the exterior image 21 and the display of the internal structure image 22. The predetermined approach region may be, for example, a region within the surface of the own vehicle icon 20 in the virtual space. The predetermined approach region may be, for example, a hemispherical region including the own vehicle icon 20 in the virtual space. The predetermined approach area may be preset and stored in ECU 10.

Image display unit 13, if the occurrence of abnormality in the in-vehicle components of the exterior of the own vehicle is detected, and displays the exterior image 21 of the own vehicle icon 20 on the display 4, the exterior image 21 of the own vehicle icon 20 may be displayed by superimposing the abnormality display 24. FIG. 4B is a diagram illustrating another display in which an abnormal display is superimposed on an own vehicle icon. In FIG. 4B, the exterior images 21 of the own vehicle icons 20 are displayed on the display 4. As shown in FIG. 4B, when an abnormality occurs in the in-vehicle component of the exterior of the own vehicle, the abnormality display 24 may be displayed by superimposing the abnormality display on the exterior images 21 of the own vehicle icon 20. In the example of FIG. 4B, the abnormality display 24 is shown vehicle as an ellipse with a dashed line.

The in-vehicle component of the exterior of the own vehicle means an in-vehicle component in which the virtual component position may exist on the exterior image 21. Examples of the in-vehicle component of the exterior of the own vehicle include tires, lights, and doors. Examples of abnormalities in the in-vehicle components other than the exterior of the own vehicle include a decrease in the air pressure of the tire, an abnormality in lights, an open state of the door, and the like. In the example of FIG. 4B, an abnormality of the left-brake lamp is indicated as the abnormality display 24. Note that the tire is also an in-vehicle component in which the virtual component position may exist on the internal structure image 22, and is also an in-vehicle component in which the virtual component position may exist on the exterior image 21. Therefore, the tire may be handled as an in-vehicle component other than the exterior of the own vehicle, or may be handled as an in-vehicle component of the exterior of the own vehicle.

In a case where the occurrence of an abnormality in the in-vehicle component is detected, the image display unit 13 may display an abnormality display indicating the occurrence of the abnormality superimposed on the own vehicle icon so as to correspond to the position of the in-vehicle component in which the abnormality has occurred in the own vehicle. At the same time, the image display unit 13 may display a button for displaying detailed information on the in-vehicle component in which the abnormality has occurred. The image display unit 13 may display detailed information about an in-vehicle component in which an abnormality has occurred, for example, by a user touching a button.

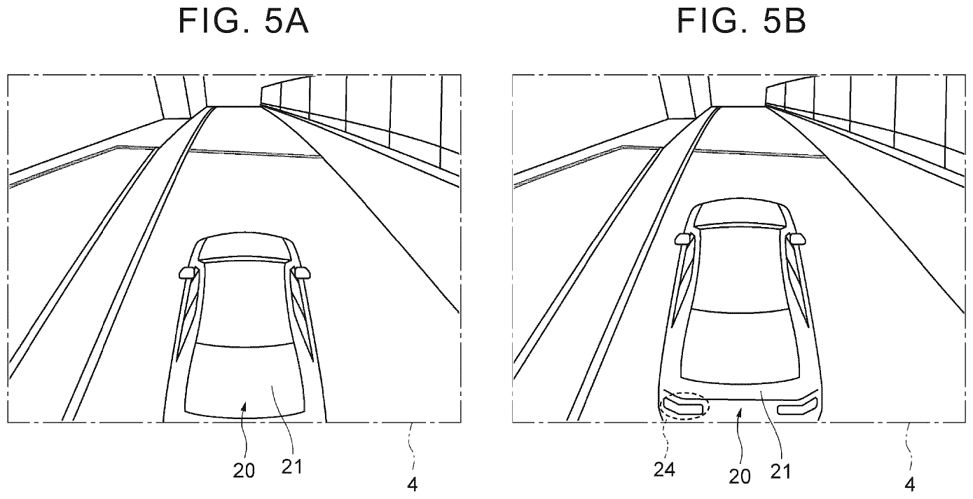

The image display unit 13 may move the virtual viewpoint 50 so that the virtual component position is included in the range displayed on the display 4 when the occurrence of an abnormality is detected in the in-vehicle component of the exterior of the own vehicle, and the virtual component position of the in-vehicle component in which the abnormality has occurred (for example, the left brake lamp) is not included in the range displayed on the display 4 (see FIG. 5A) (see FIG. 5B). The movement of the virtual viewpoint 50 may be executed in a case where it is permitted by the user's setting in advance, or may be executed in a case where the user has proposed the movement of the virtual viewpoint 50 and obtained the consent of the user.

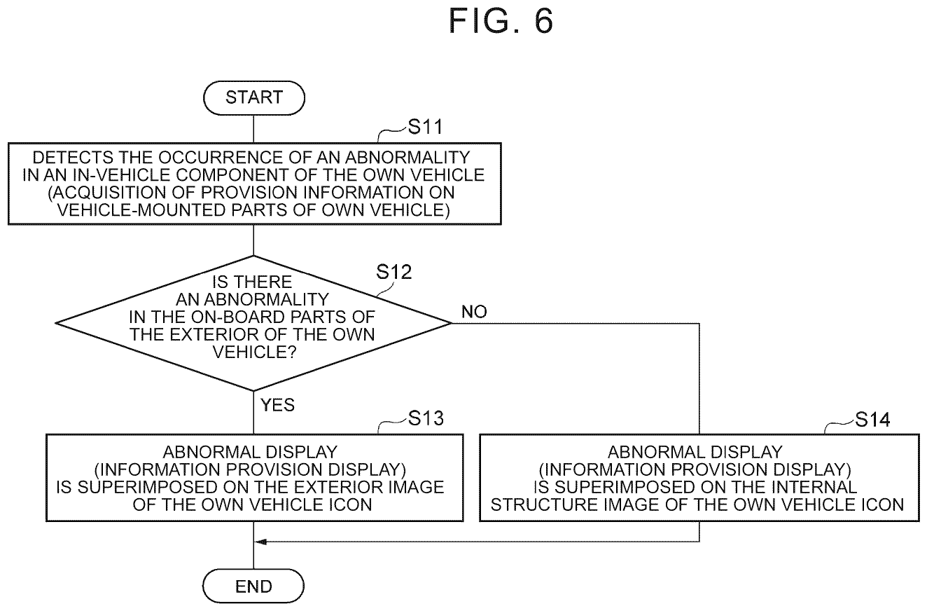

Next, an ECU 10 process of the vehicle information display device 100 will be described. FIG. 6 is a flow chart illustrating an exemplary process of ECU of FIG. 1.

As illustrated in FIG. 6, in S11, ECU 10 of the information display device 100 of the vehicle detects the occurrence of an abnormality in the in-vehicle component of the own vehicle by the abnormality detecting unit 11. ECU 10 detects, for example, an anomaly in an on-vehicle component related to a tell-tale, which is a warning light defined by laws and regulations, by a known vehicle method.

In S12, ECU 10 determines whether or not an anomaly has occurred in the in-vehicle component of the exterior of the own vehicle by the image display unit 13. ECU 10 proceeds to S13 when it is determined that the in-vehicle component in which the anomaly has occurred is a predetermined in-vehicle component in which the virtual component position may exist on the exterior images 21 (S12: YES). ECU 10 proceeds to S14 when it is determined that the in-vehicle component in which the anomaly has occurred is a predetermined in-vehicle component in which the virtual component position may exist on the internal structure images 22 (S12: NO).

In S13, ECU 10 performs an on-screen display in which the abnormality display 24 is superimposed on the exterior image 21 of the own vehicle icon 20 by the image display unit 13. ECU 10 displays the exterior image 21 of the own vehicle icon 20 on the display 4, and displays the abnormality display 24 superimposed on the exterior image 21 of the own vehicle icon 20. Thereafter, the present processing is ended.

In S14, ECU 10 performs an on-screen display in which the abnormality display 23 is superimposed on the internal structure image 22 and displayed by the image display unit 13. ECU 10 deletes the exterior image 21 of the own vehicle icon 20, displays the internal structure image 22 on the display 4, and displays the abnormality display 23 superimposed on the internal structure image 22. ECU 10 may delete the exterior images 21 of the own vehicle icon 20 in response to a user's pinch-out manipulation inputted to the touch panel of the display 4. Thereafter, the present processing is ended.

According to the information display device 100 of the vehicle described above, based on the detection information of the external sensor of the own vehicle, an image representing the surrounding environment of the own vehicle is displayed on the display 4 together with the own vehicle icon 20 corresponding to the own vehicle. When the occurrence of the abnormality is detected, the abnormality displays 23 and 24 indicating the occurrence of the abnormality are displayed so as to be superimposed on the own vehicle icon 20 so as to correspond to the position of the in-vehicle component in which the abnormality has occurred in the own vehicle. As a result, the user can intuitively recognize the in-vehicle component of the own vehicle related to the provision information as compared with, for example, a case where only the warning light of the tell tail defined by the law or the meaning of the warning light of the tell tail is concretely displayed in a sentence.

The abnormality display 23 and the abnormality display 24 indicating the occurrence of the abnormality are displayed so as to be superimposed on the own vehicle icon 20, so that the user can visually recognize the virtual component position in the own vehicle icon 20. By visually recognizing the virtual component position of the in-vehicle component in which the abnormality has occurred, the user can intuitively recognize the type and the like of the in-vehicle component in which the abnormality has occurred, as compared with, for example, a case in which only the telltale is visually recognized.

In the information display device 100 of the vehicle, the image display unit 13 generates a virtual space corresponding to the surrounding environment of the own vehicle based on the detection information of the external sensor, and displays an image in the virtual space viewed from the virtual viewpoint 50 operated by the user of the own vehicle on the display 4. The own vehicle icon 20 is a three-dimensional icon corresponding to the own vehicle arranged in the virtual space. Accordingly, since the abnormality displays 23 and 24 are displayed so as to be superimposed on the three-dimensional own vehicle icon 20, it is possible to allow the user to more intuitively recognize the in-vehicle component of the own vehicle in which the abnormality has occurred.

In the information display device 100 of the vehicle, the image display unit 13 deletes the exterior image 21 of the own vehicle icon 20 when the occurrence of an abnormality in an in-vehicle component other than the exterior of the own vehicle is detected. The image display unit 13 displays the internal structure image 22 corresponding to the internal structure of the own vehicle on the display 4. The image display unit 13 displays the abnormality display 23 superimposed on the internal structure image 22. Accordingly, it is possible to allow the user to easily recognize which in-vehicle component an abnormality has occurred in the internal structure of the own vehicle.

Although the embodiments of the present disclosure have been described above, the present disclosure is not limited to the above-described embodiments. The present disclosure may be embodied in various forms with various changes and modifications, including the above-described embodiments, based on the knowledge of those skilled in the art.

In the above-described embodiment, the image display unit 13 deletes the exterior image 21 of the own vehicle icon 20 when the occurrence of an abnormality in the in-vehicle component other than the exterior of the own vehicle is detected. The image display unit 13 displays the internal structure image 22 corresponding to the internal structure of the own vehicle on the display 4. The image display unit 13 displays the abnormality display 23 superimposed on the internal structure image 22. This feature is not mandatory. The image display unit 13, even when the occurrence of abnormality in the in-vehicle components other than the exterior of the own vehicle is detected, may be displayed by superimposing the abnormality display 23 on the exterior image 21 of the own vehicle icon 20.

In the above-described embodiment, the information display device 100 of the vehicle includes the virtual space generating unit 12 that generates the virtual space corresponding to the surrounding environment of the own vehicle based on the detection information of the external sensor, but the virtual space generating unit 12 is not essential. The own vehicle icon may be an own vehicle as 2D images displayed on the display 4 in a plan view. Even in this case, the image display unit 13 may delete the exterior image of the vehicle icon in a plan view when the occurrence of an abnormality in the in-vehicle component other than the exterior of the own vehicle is detected. The image display unit 13 may display an internal structure image in a plan view corresponding to the internal structure of the own vehicle on the display 4. The image display unit 13 may display the abnormal display by superimposing the abnormal display on the internal structure image in a plan view.

In the above-described embodiment, the abnormality detecting unit 11 that detects (acquires) the occurrence of an abnormality in the in-vehicle component of the own vehicle is illustrated as an example of the provision information acquisition unit, but the present disclosure is not limited to this example. For example, the provision information regarding the in-vehicle component of the own vehicle may be maintenance information to the in-vehicle component that is acquired under a predetermined condition and provided to the user. As the maintenance information, for example, a proposal of engine oil change with time elapsed or traveling distance as a condition, a proposal of air replenishment of a tire with time elapsed as a condition, and the like can be cited. Even when the provision information is maintenance information, the virtual component position of the in-vehicle component related to the provision information can be visually recognized by the user as in the above-described embodiment, and the same operation and effect as in the above-described embodiment can be obtained.

What is claimed is:

1. An information display device for a vehicle, displaying an image representing a surrounding environment of an own vehicle on a display based on detection information of an external sensor of the own vehicle, the information display device comprising:
a provision information acquisition unit for acquiring provision information that is information provided to a user of the own vehicle with respect to an in-vehicle component of the own vehicle; and
an image display unit for displaying an own vehicle icon corresponding to the own vehicle, on the display, wherein, when the provision information is acquired, the image display unit displays an information provision display representing the provision information, superimposed on the own vehicle icon, so as to correspond to a position of the in-vehicle component related to the provision information in the own vehicle.

2. The information display device according to claim 1, further comprising a virtual space generating unit for generating virtual space corresponding to the surrounding environment of the own vehicle, based on the detection information of the external sensor, wherein
the image display unit displays an image, in the virtual space, as viewed from a virtual viewpoint that is operated by the user of the own vehicle, on the display, and
the own vehicle icon is a three-dimensional icon corresponding to the own vehicle that is placed in the virtual space.

3. The information display device according to claim 1, wherein, when the provision information with respect to the in-vehicle component, other than an exterior of the own vehicle, is acquired, the image display unit deletes an exterior image of the own vehicle icon, displays an internal structure image corresponding to an internal structure of the own vehicle on the display, and displays the information provision display, superimposed on the internal structure image.
